(19) United States
(12) Patent Application Publication
(10) Pub. No.: US 2016/0322810 A1
(43) Pub. Date: Nov. 3, 2016

(54) SYSTEM AND METHOD FOR PROVIDING SURGE PROTECTION

(71) Applicant: Roger S. BISHOP, Dayton, NV (US)

(72) Inventor: Roger S. BISHOP, Dayton, NV (US)

(21) Appl. No.: 14/831,459

(22) Filed: Aug. 20, 2015

Related U.S. Application Data
(60) Provisional application No. 62/155,552, filed on May 1, 2015.

(51) Int. Cl. H02H 9/04; H02H 9/02

(52) U.S. Cl. CPC H02H 9/04; H02H 9/02

(57) ABSTRACT

A circuit for attenuating a surge. The circuit includes an input conductor for receiving a signal, an output conductor for outputting the signal, a plurality of stages, and at least one electrically reactive component. The plurality of stages are coupled in series in pairs between the input conductor and the output conductor. Each of the plurality of stages is configured for attenuating a portion of a surge input into the circuit via the input conductor. Each pair of coupled stages is coupled via at least one of the at least one electrically reactive component. The circuit may be provided in a system includes a source of power and a load. The circuit couples the source of power to the load. The source of power may be a direct current source of power, and the load may be a cellular telephone site.

### CROSS REFERENCE TO RELATED APPLICATION

This application claims the benefit of U.S. Provisional Application No. 62/155,552, entitled “Method for Protecting Cell Site Remote Radio Units from Transient Lightning Damage” and filed May 1, 2015, the contents of which application are incorporated herein by reference.

### FIELD OF THE INVENTION

The present invention relates to a system and method for protecting a load from a transient power surge and, more specifically, to a circuit for grounding a lighting strike in stages for protecting a cellular telephone site from damage by the lighting strike.

### BACKGROUND OF THE INVENTION

Surge suppression circuits are used to protect electronic devices from transient power surges, switching surges, lightning strikes, and other abnormal events or conditions. Such electronic devices may be susceptible to damage and destruction in the presence of a transient power surge. A transient power surge may last about 28 microseconds and have a peak voltage of about 6,000 volts and a peak current of about 3,000 amps.

A conventional surge protection circuit 400 is illustrated in FIG. 4. The circuit 400 comprises an input 411 connected to a power supply or other source and an output 421 connected to a load. The circuit 400 further comprises a gas tube 410, three metal oxide varistors 420, three transient voltage surge diodes 430, a transformer 440, a capacitor C, and two resistors R₁ and R₂. The capacitor C connects the input 411 to the output 421. A first winding 441 of the transformer connects the input 411 to a first end of the varistors 420. A second winding 442 of the transformer 440 connects the output 421 to a first end of the diodes 430. The second ends of the varistors 420 and diodes 430 are connected to ground. The gas tube 410 is connected between the input 411 and ground.

The gas tube 410 diverts a trailing portion of a transient surge to ground but does not turn on in time to divert a leading edge to ground. During the surge, the transformer 440 enters saturation, which decouples the windings 441 and 442 from each other. Thus, the surge is preventing from coupling to the windings 442 and, therefore, to the output 421. The leading edge of the transient surge passes through the first winding 441 of the transformer 440 and is grounded by the varistors 420 and the diodes 430.

### SUMMARY OF THE INVENTION

In accordance with an aspect of the present invention, there is provided a circuit for attenuating a surge. The circuit comprises an input conductor for receiving a signal, an output conductor for outputting the signal, a plurality of stages coupled in series in pairs between the input conductor and the output conductor, and at least one electrically reactive component. Each of the plurality of stages is configured for attenuating a portion of a surge input via the input conductor. Each pair of coupled stages is coupled via at least one of the at least one electrically reactive component.

In accordance with another aspect of the present invention, there is provided a system for providing power. The system comprises a source of power, a load, and a circuit coupled to the source of power and to the load. The circuit is configured for attenuating a surge of power provided by the source. The circuit comprises an input conductor for receiving a signal from the source of power, an output conductor for outputting the signal to the load, a plurality of stages coupled in series in pairs between the input conductor and the output conductor, and at least one electrically reactive component. Each of the plurality of stages is configured for attenuating a portion of a surge input via the input conductor. Each pair of coupled stages is coupled via at least one of the at least one electrically reactive component.

In accordance with yet another aspect of the present invention, there is provided a circuit for attenuating a surge. The circuit comprises a first input conductor for receiving a first signal, a first output conductor for outputting the first signal, at least a first, second, and third stage coupled in series, and at least two electrically reactive components. Each stage comprises a first input to which a first voltage is applied, a first output coupled to the first input of the each stage, and a first breakdown device coupled between the first input of the each stage and ground. The first breakdown device of the each stage is configured to turn on when the first voltage at the first input of the each stage exceeds a first threshold value and to turn off when the first voltage at the first input of the each stage decreases to less than a second threshold value. A first of the at least two electrically reactive components couple the first output of the first stage to the first input of the second stage. A second of the at least two electrically reactive components couple the first output of the second stage to the first input of the third stage.

### BRIEF DESCRIPTION OF THE DRAWINGS

For the purpose of illustration, there are shown in the drawings certain embodiments of the present invention. In the drawings, like numerals indicate like elements throughout. It should be understood that the invention is not limited to the precise arrangements, dimensions, and instruments shown. In the drawings:

FIG. 1 illustrates a surge-protected system comprising a source of power, a surge protection circuit, and a load, in accordance with an exemplary embodiment of the present invention;

FIG. 2A illustrates an exemplary embodiment of the surge protection circuit of FIG. 1, in accordance with an exemplary embodiment of the present invention;

FIG. 2B illustrates another exemplary embodiment of the surge protection circuit of FIG. 1, in accordance with an exemplary embodiment of the present invention;

FIG. 3 illustrates yet another exemplary embodiment of the surge protection circuit of FIG. 1, in accordance with an exemplary embodiment of the present invention; and

FIG. 4 illustrates a conventional surge protection circuit.

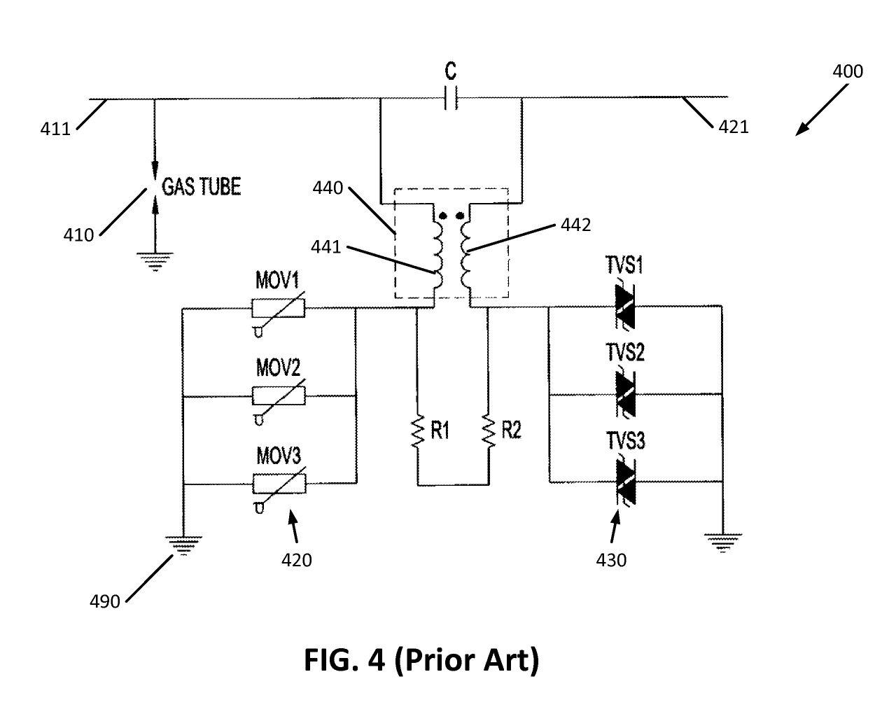

### DETAILED DESCRIPTION OF THE INVENTION

Reference to the drawings illustrating various views of exemplary embodiments of the present invention is now made. In the drawings and the description of the drawings herein, certain terminology is used for convenience only and is not to be taken as limiting the embodiments of the present invention. Furthermore, in the drawings and the description below, like numerals indicate like elements throughout.

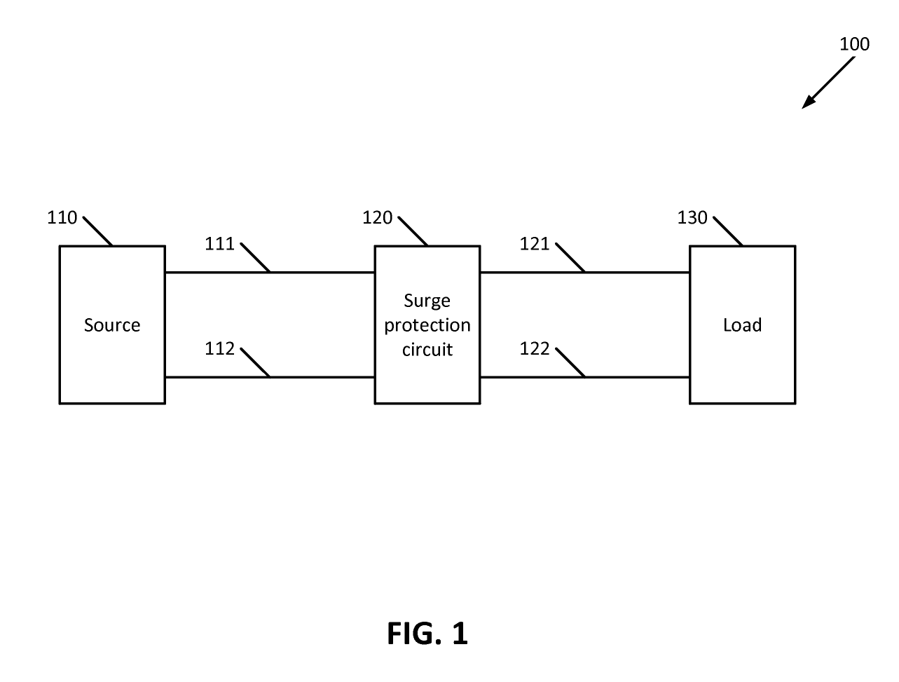

Referring now to FIG. 1, there is illustrated an exemplary embodiment of a surge-protected system, generally designated as 100, in accordance with an exemplary embodiment of the present invention. The system 100 comprises a source 110, a surge protection circuit 120, and a load 130. The surge protection circuit 120 is configured for attenuating transitory pulses of high voltage and current, such as those associated with a lightning strike, originating from the source 110.

The source 110 is connected to the surge protection circuit 120 via signal conductors/lines 111 and 112. The surge protection circuit 120 is connected to the load 130 via signal conductors/lines 121 and 122. The surge protection circuit 120 passes power or communications signals from the source 110 via the signal conductors/lines 111 and 112 to the load 130 via the signal conductors/lines 121 and 122 while attenuating transitory pulses of high voltage and current. In an exemplary embodiment, the source 110 is a DC power source; the conductors/lines 111, 112, 121, and 122 are power conductors; and the load 130 is a remote radio unit (RRU) at a cellular telephone site. Specifically, in such embodiment, the conductors/lines 111 and 121 provide line voltage and current, and the conductors/lines 112 and 122 are each a return. In an exemplary embodiment, the conductors/lines 111 and 121 are 48V lines, and the conductors/lines 112 and 122 are 48V returns.

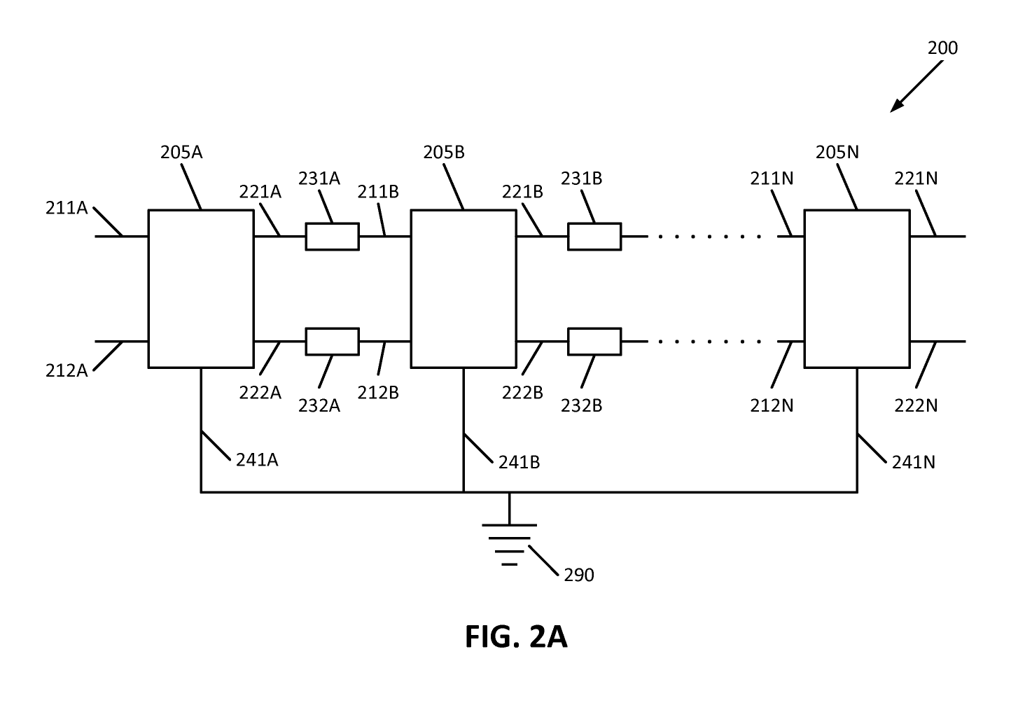

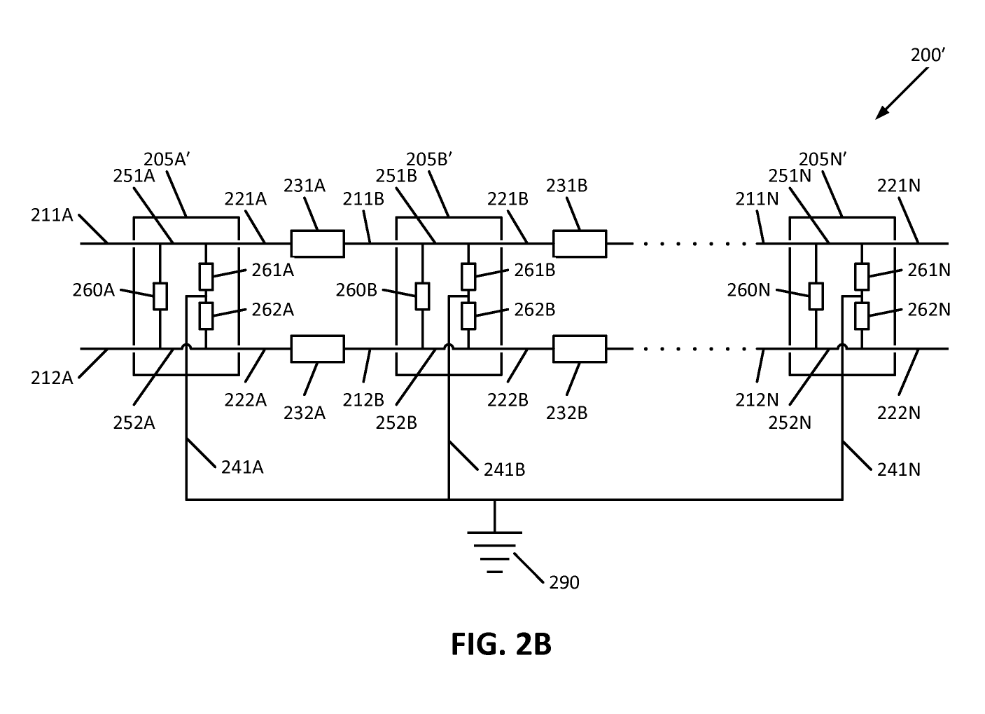

Referring now to FIG. 2A, there is illustrated an exemplary embodiment of the circuit 120, which exemplary embodiment is designated as 200, in accordance with an exemplary embodiment of the present invention. The circuit 200 comprises a plurality of stages 205A, 205B, . . . , 205N. Each stage 205A, 205B, . . . , 205N comprises a pair of inputs 211 and 212 and a pair of outputs 221 and 222, and each stage 205A, 205B, . . . , 205N is connected to a ground 290 via a ground conductor 241. The first stage 205A is connected to ground 290 via a grounding conductor 241A; the second stage 205B is connected to ground 290 via a grounding conductor 241B; and the Nth stage 205N is connected to ground 290 via a grounding conductor 241N.

The inputs to the first stage 205A are designated as 211A and 212A, and the outputs are designated as 221A and 222A. The inputs to the second stage 205B are designated as 211B and 212B, and the outputs are designated as 221B and 222B. The inputs to the Nth stage 205N are designated as 211N and 212N, and the outputs are designated as 221N and 222N. The inputs 211A and 212A to the first stage 205A are the inputs to the circuit 200. The outputs 221N and 222N of the Nth stage 205N are the outputs of the circuit 200. Each of the N stages of the circuit 200 comprises inputs 211 and 212 and outputs 221 and 222. The N stages 205A, 205B, . . . , 205N of the circuit 200 are connected in series, as seen in FIG. 2A.

Each stage 205A, 205B, . . . , 205N is coupled by a pair of electrically reactive components 231 and 232. Stated another way, each pair of adjacent stages 205A, 205B, . . . , 205N are coupled by first and second electrically reactive components 231 and 232. A reactive component 231A couples the output 221A of the first stage 205A to the input 211B of the second stage 205B. A reactive component 232A couples the output 222A of the first stage 205A to the input 212B of the second stage 205B. A reactive component 231B couples the output 221B of the second stage 205A to an input of a next higher stage. A reactive component 232B couples the output 222B of the second stage 205B to an input of a next higher stage. A first reactive component following a stage preceding the Nth stage couples such stage to the input 211N of the Nth stage 205B. A second reactive component following the stage preceding the Nth stage couples such stage to the input 212N of the Nth stage 205B.

In applications in which the load 130 is sensitive to overcurrent, the circuit 200 is provided for filtering signals provided by the supply 110 at the inputs 211A and 212A of the circuit 200 and, specifically, for shunting overcurrent present at the inputs 211A and 212A to ground 290 and reducing overvoltage at the inputs 211A and 212A before reaching the inputs 121 and 122 of the load 130. An unwanted transient power surge may present overcurrent and overvoltage at the inputs 211A and 212A of the circuit 200 in the case of a lightning strike on the supply 110, for example.

The circuit 200 provides protection against common-mode surge events, in which an unwanted transient power surge elevates the voltage present in each of the inputs 211A and 212A. Unlike the conventional circuit 400, which only provides protection against common-mode surge events, the circuit 200 also provides protection against differential-mode surge events, in which an unwanted transient power surge elevates the voltage present in one of the inputs 211A and 212A relative to the other of the inputs 211A and 212A. The circuit 200 is configured in each of the stages 205A, 205B, . . . , 205N to shunt overcurrent resulting from an unwanted differential-mode surge between the inputs 211 and 212 and to shunt overcurrent resulting from an unwanted common-mode surge events to ground 290 so that the overcurrent does not pass through the outputs 221N and 222N to the load 130. Thus, the circuit 200 is also configured in each of the stages 205A, 205B, . . . , 205N to attenuate the overvoltage presented at the inputs 211 and 212 as a result of a power surge.

Each stage 205A, 205B, . . . , 205N shunts a portion of the overcurrent provided at the inputs 211A and 212A to ground 290. In an exemplary embodiment, the stages 205A, 205B, . . . , 205N turn on in a cascading fashion to shunt the overcurrent present at the inputs 211A and 212A to ground 290. In such embodiment, the stage 205A turns on before the stage 205B; the stage 205B turns on before its succeeding stage; and the stage 205N turns on after its preceding stage. Each succeeding stage 205 turns on after its preceding stage 205 and shunts a portion of the overcurrent present at the inputs 211A and 212A to ground 290. Because of cascading turn-on, the transient current and voltage of the stages 205 during a surge event decreases from stage to stage as succeeding stages 205 shunt further portions of the overcurrent to ground 290 not shunted to ground by preceding stages 205.

Cascading turn-on is desirable for a few reasons. First, earlier stages 205 in the circuit 200 may be constructed from components that are able to withstand the high current and voltages associated with a leading edge of a transient power surge but may be unable to completely attenuate the transient power surge. Thus, later stages 205 may be used to further attenuate the power surge. Such later stages may be constructed from components that are better suited for further attenuating the transient power surge to levels lower than the earlier stages 205 are able to, but such components may not be capable of withstanding the high current and voltages associated with the leading edge of the transient power surge. Thus, the components in the later stages are desirably protected from the leading edge of the transient power surge by more durable early stages and are desirably presented with the power surge only after it has been attenuated by the earlier stages 205. Second, cascading turn-on provides each stage with time to shunt its portion of overcurrent to ground before the power surge is presented to succeeding stages. Although the components in the earlier stages 205 may be able to withstand high current and voltage, they may have slower turn-on times that the components in later stages 250.

To provide for the cascading turn-on of the stages 205A, 205B, . . . , 205N, in an exemplary embodiment, the reactance of each of the electrically reactive components 231 and 232 is positive. Because of their positive electrical reactance, the electrically reactive components 231 and 232 resist the change of current from one stage 205 to the next stage 205. To a leading edge of the unwanted transient power surge, the electrically reactive components 231 and 232 appear as high impedances. In an exemplary embodiment, the impedance offered by the electrically reactive components 231 and 232 is between 0.3Ω and 1Ω.

In a surge event, the first stage 205A turns on to shunt a first portion of the overcurrent present at the inputs 211A and 212A to ground 290 before the second stage 205B turns on to shunt a second portion of the overcurrent to ground 290 because the components 231A and 232A resist the passage of the transient overcurrent present in the first stage 205A from the outputs 221A and 222A to the inputs 211B and 212B of the second stage 205B. As the power surge settles within the first stage 205A, it eventually passes through the electrically reactive components 231A and 232A to the second stage 205B. When the second stage 205B turns on in the presence of the power surge to shunt a second portion of the overcurrent present at the inputs 211B and 212B to ground 290, it does so because the components 231B and 232B resist the passage of the transient overcurrent present in the second stage 205B from the outputs 221B and 222B to the inputs of the succeeding stage. Every next succeeding stage turns on after its preceding stage because of the components 231 and 232 present at each succeeding stage's inputs 211 and 212. The last stage to turn on is the Nth stage 205N, which turns on to shunt an Nth portion of the overcurrent present at the inputs 211N and 212N to ground 290. The current that passes through the Nth stage is capable of being handled or absorbed by the load 130 without damage. In an exemplary embodiment, each of the electrically reactive components 231 and 232 is an inductor. Each inductor 231 and 232 may have an inductance of between 5 μH and 10 μH.

In an exemplary embodiment, each stage 205A, 205B, . . . , 205N comprises one or more breakdown devices. Each breakdown device does not conduct until a voltage across it exceeds a first threshold value of the device, each breakdown device clamps the voltage at a second threshold, and each breakdown device stops conducting when the voltage across it falls below a third threshold value of the device. The second threshold value may be equal to the first threshold value, greater than the first threshold value, or less than the first threshold value. The third threshold is less than the first threshold. While conducting, such as in the presence of an overvoltage resulting from a power surge, each breakdown device shunts a portion of the overcurrent resulting from the power surge to ground 290. The breakdown devices of the stages 205 do not shunt normal or desired signals provided by the source 100 to the inputs 211A and 212A to ground 290 because the voltage level of normal or desired signals is below the first threshold values of all of the breakdown devices in the circuit 200.

The breakdown, clamping, and turn-off voltages of each stage 205A, 205B, . . . , 205N are application dependent. Generally, the stages 205A, 205B, . . . , 205N are sized for a coordinated breakdown based on the DC or signal voltage provided at the inputs 211A and 212A. In an exemplary embodiment in which the inputs 211A and 212A are respectively 48V and −48V, if the maximum let-through voltage at the outputs 221N and 222N is 100V, the stage 205A may be selected to have a 600V DC breakdown voltage, a 150V DC clamping voltage, and a <80V DC turn off voltage; the stage 205B may be selected to have a 82V breakdown voltage and a 135V DC clamping voltage; and the stage 205N may be selected to have a 54V breakdown voltage and a 98V clamping voltage. Thus, the clamping voltage of the final stage 205N is desirably between 95% and 98% of the maximum let-through voltage.

Continuing with the exemplary embodiment in which each stage 205A, 205B, . . . , 205N comprises one or more breakdown devices, the first and second threshold values of the one or more breakdown devices of each stage 205 are greater than the first and second threshold values of the one or more breakdown devices of any succeeding stage 205. Thus, the first and second threshold values of the one or more breakdown devices of the first stage 205A are greater than the first and second threshold values of the one or more breakdown devices of the second stage 205B; the first and second threshold values of the one or more breakdown devices of the second stage 205B are greater than the first and second threshold values of the one or more breakdown devices of the next stage; etc.

The one or more breakdown devices of the first stage 205A turn on when a voltage across them exceeds their first threshold value, such as when in the presence of overvoltage resulting from a transient power surge, to shunt a first portion of overcurrent resulting from the transient power surge to ground 290. The one or more breakdown devices of the first stage 205A thereby reduce the overvoltage present in the first stage 205A to a first lower level equal to the second threshold value, at which point the one or more breakdown devices of the first stage 205A turn off. The residual overvoltage may still be dangerous to the load 130. Thus, the circuit 200 employs succeeding stages 205B . . . 205B to further attenuate the overvoltage and overcurrent.

The one or more breakdown devices of the second stage 205B turn on when a voltage across them exceeds their first threshold value, such as when in the presence of overvoltage resulting from a transient power surge, to shunt a second portion of overcurrent resulting from the transient power surge to ground 290. The one or more breakdown devices of the second stage 205B thereby reduce the overvoltage present in the first stage 205B to a second lower level equal to the second threshold value, at which point the one or more breakdown devices of the second stage 205B turn off.

The one or more breakdown devices of succeeding stages operate similarly to turn on in a cascading fashion to shunt portions of the overcurrent to ground and to reduce the overvoltage in stages. Thus, during cascading turn-on of the circuit 200, such as in embodiments in which the reactance of each of the electrically reactive components 231 and 232 is positive, the level of transient overcurrent and overvoltage present in each of the stages 205A, 205B, . . . , 205N decreases from one stage to the next. Cascading turn-on of the stages 205A, 205B, . . . , 205N allows for more durable breakdown devices, which consequently have higher first and second threshold values, to be used in the preceding stages 205 compared with succeeding stages 205. Cascading turn-on of the stages 205A, 205B, . . . , 205N allows for more complete attenuation of an unwanted transient power surge that could not be fully attenuated by breakdown devices that are durable enough to handle a leading edge of the power surge.

It is to be understood that the first and second threshold values for the one or more breakdown devices of each stage 205A, 205B, . . . , 205N may differ from the first and second threshold values for the one or more breakdown devices of the other stages 205A, 205B, . . . , 205N. Furthermore, the first and second threshold values for each of the one or more breakdown devices in a stage 205 may differ from one another.

In an exemplary embodiment, the one or more breakdown devices of the stages 205A, 205B, . . . , 205N may be any combination of spark gap devices, e.g., gas discharge tubes, and solid-state breakdown devices, e.g., metal oxide varistors, transient voltage surge (TVS) diodes, and other monolithic silicon devices, such as TBU® High Speed Protectors sold by Bourns and silicon diode for alternating current (SIDAC) devices. In another exemplary embodiment, the first stage 205A may comprise one or more spark gap devices; and the second stage 205B and succeeding stages may each comprise one or more solid-state breakdown devices.

Referring now to FIG. 2B, there is illustrated an exemplary embodiment of the circuit 200, which exemplary alternative embodiment is generally designated as 200′, in accordance with an exemplary embodiment of the present invention. The circuit 200′ comprises exemplary embodiments of the stages 205A, 205B, . . . , 205N, which exemplary embodiments are respectively designated as 205A′, 205B′, . . . , 205N′ in FIG. 2B. Otherwise, the circuit 200′ is similar to the circuit 200.

Each of the N stages 205A′, 205B′, . . . , 205N′ comprises two conductors 251 and 252 and three breakdown devices 260, 261, and 262. The first stage 205A′ comprises two conductors 251A and 252A and three breakdown devices 260A, 261A, and 262A. The second stage 205B′ comprises two conductors 251B and 252B and three breakdown devices 260B, 261B, and 262B. The Nth stage comprises two conductors 251N and 252N and three breakdown devices 260N, 261N, and 262N. Each breakdown device 260, 261, 262 does not conduct until a voltage across it exceeds a first threshold value. Each breakdown device 260, 261, 262 stops conducting when a voltage across it falls below a second threshold value. The first and second threshold values for the breakdown devices 260, 261, and 262 of each stage 205′ may differ from the first and second threshold values for the breakdown devices 260, 261, and 262 of the other stages 205′.

In each of the N stages 205′, the conductor 251 couples the input 211 of the stage to the output 221, and the conductor 252 couples the input 212 of the stage to the output 222. In the first stage, the conductor 251A couples the input 211A to the output 221A, and the conductor 252A couples the input 212A to the output 222A. In the second stage, the conductor 251B couples the input 211B to the output 221B, and the conductor 252B couples the input 212B to the output 222B. In the Nth stage, the conductor 251N couples the input 211N to the output 221N, and the conductor 252N couples the input 212N to the output 222N.

In each of the N stages 205′, the breakdown device 260 is connected between the conductor 251 and the conductor 252 of the stage. Specifically, the breakdown device 260 has a first end coupled with the conductor 251 and a second end coupled with the conductor 252. In the first stage, the breakdown device 260A is connected between the conductor 251A and the conductor 252A. In the second stage, the breakdown device 260B is connected between the conductor 251B and the conductor 252B. In the Nth stage, the breakdown device 260N is connected between the conductor 251N and the conductor 252N.

In each of the N stages 205′, the breakdown device 261 is connected between the conductor 251 and ground 290, and the breakdown device 262 is connected between the conductor 252 and ground 290. Specifically, the breakdown device 261 has a first end coupled to the conductor 251 and a second end coupled to ground 290, and the breakdown device 262 has a first end coupled to the conductor 252 and a second end coupled to the ground 290. The breakdown devices 261 and 262 are connected in series between the conductors 251 and 252, and their series connection to one another is grounded by the conductor 241. In the first stage, the breakdown device 261A is connected between the conductor 251A and ground 290, and the breakdown device 262A is connected between the conductor 252A and ground 290. In the second stage, the breakdown device 261B is connected between the conductor 251B and ground 290, and the breakdown device 262B is connected between the conductor 252B and ground 290. In the Nth stage, the breakdown device 261N is connected between the conductor 251N and ground 290, and the breakdown device 262AN is connected between the conductor 252N and ground 290.

The breakdown devices 260 in the stages 205A′, 205B′, . . . , 205N′ provide for protection from differential-mode surges. In the presence of overvoltage between the inputs 211A and 212A resulting from an unwanted transient power surge, the breakdown devices 260 in the stages 205A′, 205B′, . . . , 205N′ operate to shunt overcurrent resulting from the power surge between the conductors 251 and 252 to evenly distribute the overcurrent between the conductors 251 and 252 to convert the differential-mode surge to a common-mode surge. Specifically, for each breakdown device 260, when a voltage across such device 260 exceeds its first threshold value, the device 260 turns-on to conduct current between the conductors 251 and 252. The breakdown device 260A in the stage 205A′ shunts overcurrent between the conductors 251A and 252A; the breakdown device 260B in the stage 205B′ shunts overcurrent between the conductors 251B and 252B; and the breakdown device 260N in the stage 205N′ shunts overcurrent between the conductors 251N and 252N.

The breakdown devices 261 and 262 in the stages 205A′, 205B′, . . . , 205N′ provide for protection from common-mode surges. In the presence of overvoltage at the inputs 211A and 212A relative to ground 290 resulting from an unwanted transient power surge, the breakdown devices 261 and 262 in the stages 205A′, 205B′, . . . , 205N′ operate to shunt overcurrent resulting from the power surge from the respective conductors 251 and 252 to ground 290. Specifically, for each breakdown device 261, when a voltage across such device 261 exceeds its first threshold value, the device 261 turns-on to conduct current between the conductor 251 and ground 290, and for each breakdown device 262, when a voltage across such device 262 exceeds its first threshold value, the device 262 turns-on to conduct current between the conductor 252 and ground 290.

The breakdown device 261A in the stage 205A′ operates to shunt the overcurrent in the conductor 251A to ground 290; the breakdown device 261B in the stage 205B′ operates to shunt the overcurrent in the conductor 251B to ground 290; and the breakdown device 261N in the stage 205N′ operates to shunt the overcurrent in the conductor 251N to ground 290. The breakdown device 262A in the stage 205A′ operates to shunt the overcurrent in the conductor 252A to ground 290; the breakdown device 262B in the stage 205B′ operates to shunt the overcurrent in the conductor 252B to ground 290; and the breakdown device 262N in the stage 205N′ operates to shunt the overcurrent in the conductor 252N to ground 290.

Each stage 205A′, 205B′, . . . , 205N′ shunts a portion of the overcurrent provided at the inputs 211A and 212A to ground 290. In an exemplary embodiment, the stages 205A′, 205B′, . . . , 205N′ turn on in a cascading fashion in the presence of overcurrent present at the inputs 211A and 212A. In such embodiment, the stage 205A′ turns on before the stage 205B′; the stage 205B′ turns on before its succeeding stage; and the stage 205N′ turns on after its preceding stage. Because of cascading turn-on, the transient current through the stages 205A′, 205B′, . . . , 205N′ during a surge event decreases from stage to stage. Cascading turn-on of the stages 205A′, 205B′, . . . , 205N′ is desirable for reasons similar to those discussed above with respect to the stages 205A, 205B, . . . , 205N.

In the case of a differential surge at the inputs 211A and 212A, the stages 205A′, 205B′, . . . , 205N′ turn on in a cascading fashion to pass overcurrent between the conductors 251 and 252 to evenly distribute the overcurrent between the conductors 251 and 252 to convert the differential-mode surge to a common-mode surge. In the case of a common mode surge at the inputs 211A and 212A, the stages 205A′, 205B′, . . . , 205N′ turn on in a cascading fashion to shunt overcurrent in the conductors 251 and 252 to ground 290. In the case of both a differential surge and a common mode surge at the inputs 211A and 212A, the stages 205A′, 205B′, . . . , 205N′ turn on in a cascading fashion to pass overcurrent between the conductors 251 and 252 to evenly distribute the overcurrent between the conductors 251 and 252 and to shunt overcurrent in the conductors 251 and 252 to ground 290.

To provide for the cascading turn-on of the stages 205A′, 205B′, . . . , 205N′, in an exemplary embodiment, the reactance of each of the electrically reactive components 231 and 232 is positive. Because of their positive electrical reactance, the electrically reactive components 231 and 232 resist the change of current from one stage 205′ to the next stage 205′. To a leading edge of the unwanted transient power surge, the electrically reactive components 231 and 232 appear as high impedances. In an exemplary embodiment, the impedance offered by the electrically reactive components 231 and 232 is between 0.3Ω and 1Ω

In a surge event, each stage 205′ turns on before its succeeding stage 205′ to shunt a portion of the overcurrent to ground 290. Thus, the first stage 205A′ turns on to shunt a first portion of the overcurrent present at the inputs 211A and 212A to ground 290 before the second stage 205B′ turns on to shunt a second portion of the overcurrent to ground 290 because the components 231A and 232A resist the passage of the transient overcurrent present in the first stage 205A′ from the outputs 221A and 222A to the inputs 211B and 212B of the second stage 205B′. As the power surge settles within the first stage 205A, it eventually passes through the electrically reactive components 231A and 232A to the second stage 205B′. When the second stage 205B′ turns on in the presence of the power surge to shunt a second portion of the overcurrent present at the inputs 211B and 212B to ground 290, it does so because the components 231B and 232B resist the passage of the transient overcurrent present in the second stage 205B′ from the outputs 221B and 222B to the inputs of the succeeding stage. Every next succeeding stage turns on after its preceding stage because of the components 231 and 232 present at each succeeding stage's inputs 211 and 212. The last stage to turn on is the Nth stage 205N′, which turns on to shunt an Nth portion of the overcurrent present at the inputs 211N and 212N to ground 290. The current that passes through the Nth stage is capable of being handled or absorbed by the load 130 without damage. In an exemplary embodiment, each of the electrically reactive components 231 and 232 is an inductor. Each inductor 231 and 232 may have an inductance of between 5 μH and 10 μH.

In the exemplary embodiment in which the stages 205A′, 205B′, . . . , 205N′ turn on in a cascading fashion, the first and second threshold values of the breakdown devices 260, 261, and 262 of each stage are greater than the respective first and second threshold values of the breakdown devices 260, 261, and 262 of its succeeding stage. Thus, the first and second threshold values of the breakdown devices 260A, 261A, and 262A of the first stage 205A′ are greater than the respective first and second threshold values of the breakdown devices 260B, 261B, and 262B of the second stage 205B′; the first and second threshold values of the breakdown devices 260B, 261B, and 262B of the second stage 205B′ are greater than the respective first and second threshold values of the one or more breakdown devices of the next stage; etc.

The breakdown devices 260A, 261A, and 262A of the first stage 205A′ turn on when a voltage across them exceeds their first threshold value, such as when in the presence of overvoltage resulting from a transient power surge. The breakdown device 260A shunts overcurrent resulting from the transient power surge between the conductors 251A and 252A, and the breakdown devices 261A, and 262A shunt a first portion of the overcurrent to ground 290. The one or more breakdown devices of the first stage 205A′ thereby reduce the overvoltage present in the first stage 205A′ to a first lower level equal to the second threshold value of the breakdown devices 260A, 261A, and 262A, at which point the breakdown devices 260A, 261A, and 262A turn off. The first lower level of overvoltage may still be dangerous to the load 130. Thus, the circuit 200′ employs succeeding stages 205B′ . . . 205B′ to further attenuate the overvoltage and overcurrent.

The breakdown devices 260B, 261B, and 262B of the second stage 205B′ turn on when a voltage across them exceeds their first threshold value, such as when in the presence of the first lower level of overvoltage. The breakdown device 260B shunts overcurrent resulting from the transient power surge between the conductors 251B and 252B, and the breakdown devices 261B, and 262B shunt a second portion of the overcurrent to ground 290. The one or more breakdown devices of the second stage 205B′ thereby reduce the overvoltage present in the second stage 205B′ from the first lower level to a second lower level equal to the second threshold value of the breakdown devices 260B, 261B, and 262B, at which point the breakdown devices 260B, 261B, and 262B turn off. The second lower level of overvoltage may still be dangerous to the load 130. Thus, the circuit 200′ employs succeeding stages 205C′ . . . 205N′ to further attenuate the overvoltage and overcurrent.

The breakdown devices 260, 261, and 262 of the succeeding stages 205C′ . . . 205N′ operate similarly to turn on in a cascading fashion to shunt portions of the overcurrent to ground 290 and to reduce the overvoltage in the stages 205C′ . . . 205N′. Thus, during cascading turn-on of the circuit 200′, such as in embodiments in which the reactance of each of the electrically reactive components 231 and 232 is positive, the level of transient overcurrent and overvoltage present in each of the stages 205A′, 205B′, . . . , 205N′ decreases from one stage to the next. Cascading turn-on of the stages 205A′, 205B′, . . . , 205N′ allows for more durable breakdown devices, which consequently have higher first and second threshold values, to be used in the preceding stages 205′ compared with succeeding stages 205′. Cascading turn-on of the stages 205A′, 205B′, . . . , 205N′ allows for more complete attenuation of an unwanted transient power surge that could not be fully attenuated by breakdown devices that are durable enough to handle a leading edge of the power surge.

It is to be understood that the first and second threshold values for the one or more breakdown devices of each stage 205A′, 205B′, . . . , 205N′ may differ from the first and second threshold values for the one or more breakdown devices of the other stages 205A′, 205B′, . . . , 205N′. Furthermore, the first and second threshold values for each of the breakdown devices 260, 261, and 262 in a stage 205′ may differ from one another.

The breakdown, clamping, and turn-off voltages of each stage 205A′, 205B′, . . . , 205N′ are application dependent. Generally, the stages 205A′, 205B′, . . . , 205N′ are sized for a coordinated breakdown based on the DC or signal voltage provided at the inputs 211A and 212A. In an exemplary embodiment in which the inputs 211A and 212A are respectively 48V and −48V, if the maximum let-through voltage at the outputs 221N and 222N is 100V, the stage 205A′ may be selected to have a 600V DC breakdown voltage, a 150V DC clamping voltage, and a <80V DC turn off voltage; the stage 205B′ may be selected to have a 82V breakdown voltage and a 135V DC clamping voltage; and the stage 205N′ may be selected to have a 54V breakdown voltage and a 98V clamping voltage. Thus, the clamping voltage of the final stage 205N′ is desirably between 95% and 98% of the maximum let-through voltage.

In relevant embodiments, the higher breakdown voltage of the breakdown devices 260A, 261A, and 262A compared with the breakdown voltage of the breakdown devices 260B, 261B, and 262B is supported by the reactive components 231A and 232A resisting passage of transient overcurrent between the stages 205A and 205B. Thus, the breakdown devices 260A, 261A, and 262A handle the highest levels of overcurrent in the circuit 200′, typically resulting from the leading edge of a transient power surge, by evening differential overcurrent and shunting a portion of the overcurrent to ground 290. The higher breakdown voltage of the breakdown devices 260B, 261B, and 262B compared with the breakdown voltage of the breakdown devices of the succeeding stage is supported by the reactive components 231B and 232B resisting passage of transient overcurrent current between the stage 205B and the succeeding stage. Thus, the breakdown devices 260B, 261B, and 262B handle the next highest levels of overcurrent in the circuit 200′ by evening differential overcurrent and shunting a portion of the overcurrent to ground 290. Succeeding stages through to the Nth stage 205N′ have breakdown devices 260, 261, and 262 with progressively lower breakdown thresholds supported by reactive components 231 and 232. The succeeding stages through to the Nth stage 205N′ handle progressively lower levels of transient overcurrent in the circuit 200′ by evening differential overcurrent and shunting a portion of the overcurrent to ground 290.

In an exemplary embodiment, the breakdown devices 260, 261, and 262 of the stages 205A′, 205B′, . . . , 205N′ in the circuit′ may be any combination of spark gap devices, e.g., gas discharge tubes, and solid-state breakdown devices, e.g., metal oxide varistors, transient voltage surge (TVS) diodes, and other monolithic silicon devices, such as TBU® High Speed Protectors sold by Bourns and silicon diode for alternating current (SIDAC) devices. In another exemplary embodiment, the first stage 205A′ may comprise one or more spark gap devices; and the second stage 205B′ and succeeding stages may each comprise one or more solid-state breakdown devices.

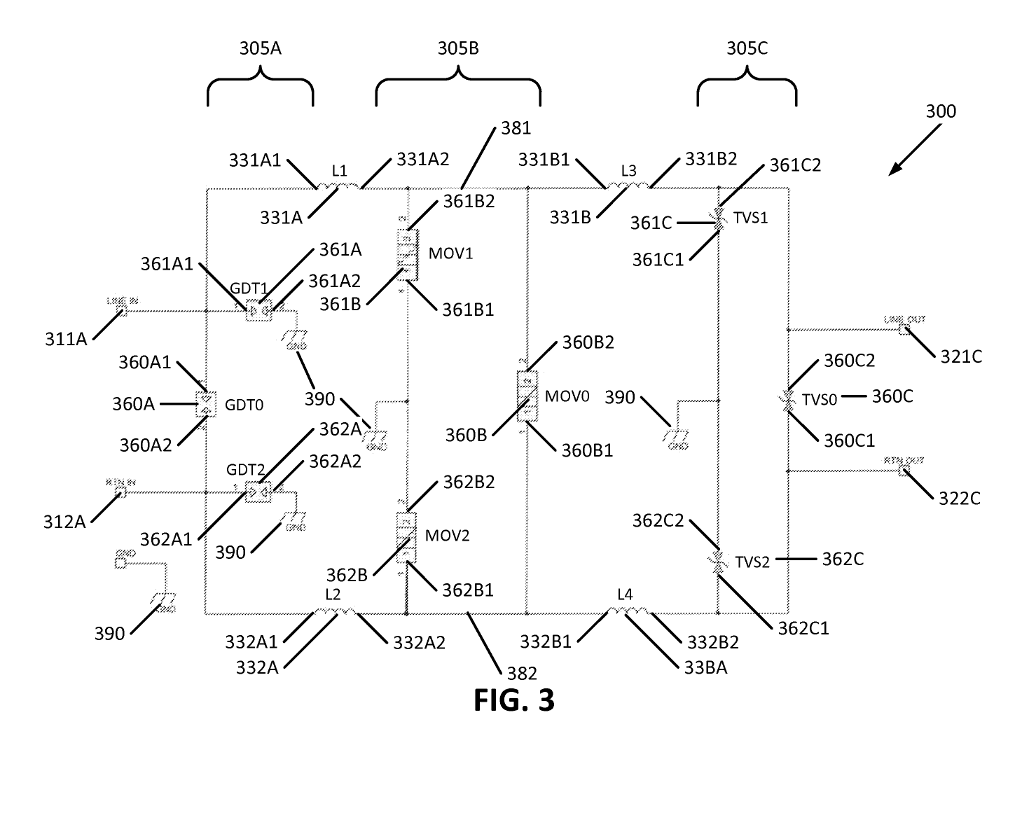

Referring now to FIG. 3, there is illustrated an exemplary embodiment of the circuit 200′, which exemplary embodiment is generally designated as 300, in accordance with an exemplary embodiment of the present invention. The circuit 300 is an exemplary embodiment of the circuit 200′ having three stages and various components discussed herein.

The circuit 300 comprises a LINE IN 311A, an RTN IN 312A, a LINE OUT 321C, and an RTN OUT 322C corresponding, respectively, to the input 211A, input 212A, output 221N, and output 222N of the circuit 200′. LINE IN 311A and RTN IN 312A are connected to the power supply 110 via the power lines 112A and 112B, respectively. LINE OUT 321C and RTN OUT 322C are connected to the load 120 by the power lines 121 and 122, respectively.

The circuit 300 protects the load 120 from a power surge caused by a lightning strike to the power supply 110 by shunting most, e.g., 99.9% or more, of the transient surge energy coupled into LINE IN 311A and RTN IN 312A to ground to protect the load 120 from damage. In the exemplary embodiment of the circuit 300 illustrated in FIG. 3, LINE IN 311A and RTN IN 312A are DC inputs. Thus, LINE OUT 321C and RTN OUT 322C are DC outputs.

The circuit 300 further comprises three gas discharge tubes (GDTs) in a GDT stage 305A (corresponding to the stage 205A′ in the circuit 200′): GDT0 360A (hereinafter “GDT1”), GDT1 361A (hereinafter “GDT2”), and GDT2 362A (hereinafter “GDT2”), corresponding, respectively, to the breakdown devices 260A, 261A, and 262A of the circuit 200′. GDT0 comprises a first end 360A1 and a second end 360A2. GDT1 comprises a first end 361A1 and a second end 361A2. GDT2 comprises a first end 362A1 and a second end 362A2. The first end 360A1 of GDT0 is connected to LINE IN 311A and to the first end 361A1 of GDT1. The second end 360A2 of GDT0 is connected to RTN IN 312A and to the first end 362A1 of GDT2. The first end 361A1 of GDT1 is connected to LINE IN 311A. The second end 361A2 of GDT1 is connected to ground 390. The first end 362A1 of GDT2 is connected to RTN IN 312A. The second end 362A2 of GDT2 is connected to ground 390. In an exemplary embodiment GDT0, GTD1, and GDT2 are selected to have the same characteristics. In an exemplary embodiment, the breakdown voltage of GDT0, GTD1, and GDT2 is 600V, the clamping voltage is 150V, and the turn-off voltage is less than 80V.

Also included in the circuit 300 are four inductors, L1 331A (hereinafter “L1”), L2 332A (hereinafter “L3”), L3 331B (hereinafter “L2”), and L4 332B (hereinafter “L4”), corresponding, respectively, to the reactive components 231A, 232A, 231B, and 232B of the circuit 200′. L1 comprises a first end 331A1 and a second end 331A2. L2 comprises a first end 332A1 and a second end 332A2. L3 comprises a first end 331B1 and a second end 331B2. L4 comprises a first end 332B1 and a second end 332B2. The first end 331A1 of inductor L1 is coupled to LINE IN 311A, the first end 361A1 of GDT1, and the first end 360A1 of GDT0. The second end 331A2 of the inductor L1 is coupled to the first end 331B1 of the inductor L3. The second end 331B2 of the inductor L3 is coupled to LINE OUT 321C. The first end 332A1 of inductor L2 is coupled to RTN IN 312A, the first end 362A1 of GDT2, and the second end 360A2 of GDT0. The second end 332A2 of the inductor L2 is coupled to the first end 332B1 of the inductor L4. The second end 332B2 of the inductor L4 is coupled to RTN OUT 322C. In an exemplary embodiment, the inductance of each of the inductors L1 through L4 is between 5 μH to 10 μH.

The circuit 300 further comprises three metal oxide varistors (MOVs) in a MOV stage 305B (corresponding to the stage 205B′ in the circuit 200′): MOV0 360B, MOV1 361B, and MOV2 362B, corresponding, respectively, to the breakdown devices 260B, 261B, and 262B of the circuit 200′. MOV0 comprises a first end 360B1 and a second end 360B2. MOV1 comprises a first end 361B1 and a second end 361B2. MOV2 comprises a first end 362B1 and a second end 362B2. The first end 360B1 of MOV0 is coupled to the second end 332A2 of the inductor L2 and to the first end 332B1 of the inductor L4. The second end 360B2 of MOV0 is coupled to the second end 331A2 of the inductor L1 and to the first end 332B1 of the inductor L3. The first end 361B1 of MOV1 is coupled to the ground 390. The second end 361B2 of MOV1 is coupled to the second end 331A2 of the inductor L1 and to the first end 331B1 of the inductor L3. The first end 362B1 of MOV2 is coupled to the second end 333A2 of the inductor L2 and to the first end 332B1 of the inductor L4. The second end 362B12 of MOV2 is coupled to the ground 390. In an exemplary embodiment MOV0, MOV1, and MOV2 are selected to have the same characteristics. In an exemplary embodiment, the breakdown voltage of MOV0, MOV1, and MOV2 is 82V, and the clamping voltage is 135V.

The circuit 300 further comprises three transient voltage surge (TVS) diodes in a TVS stage 305C (corresponding to the stage 205N′ in the circuit 200′): TVS0 360C (hereinafter “TVS0”), TVS1 361C (hereinafter “TVS1”), and TVS2 362C (hereinafter “TVS2”), corresponding, respectively, to the breakdown devices 260N, 261N, and 262N of the circuit 200′. TVS0 comprises a first end 360C1 and a second end 360C2. TVS1 comprises a first end 361C1 and a second end 361C2. TVS2 comprises a first end 362C1 and a second end 362C2. The first end 360C1 of TVS0 is coupled to RTN OUT 322C, and the second end 360C2 of TVS0 is coupled to LINE OUT 321C. The first end 361C1 of TVS1 is coupled to ground. The second end 361C2 of TVS1 is coupled to the second end 331B2 of the inductor L3, LINE OUT 321C, and the second end 360C2 of TVS0. The first end 362C1 of TVS2 is coupled to the second end 332B2 of the inductor L4, RTN OUT 322C, and the first end 360C1 of TVS0. The second end 362C2 of TVS2 is coupled to ground. In an exemplary embodiment TVS0, TVS1, and TVS2 are selected to have the same characteristics. In an exemplary embodiment, the breakdown voltage of TVS0, TVS1, and TVS2 is 54V, and the clamping voltage is 98V.

GDT0, GDT1, and GTD2 provide primary surge protection from transient surge energy coupled into LINE IN 311A and RTN IN 312A, such as from a lighting strike to the power supply 110. GDT1 and GDT2 offer common mode protection in, while GDT0 offers differential mode protection in.

Transient surge energy that is coupled onto LINE IN 311A and RTN IN 312A in either of the two modes will encounter instantaneously high impedance due to the presence of the inductors L1 and L2. This instantaneously high impedance provides enough time for GDT1 and GDT2 (for common mode surges) and GDT0 (for differential mode surges) to reach their first threshold voltage (breakdown voltage), thereby shunting most of the surge energy safely to ground 390. In an exemplary embodiment, the GDT stage 305A shunts up to about 90% of the overcurrent at LINE IN 311A and RTN IN 312A to ground 390, wherein “about 90%” may mean between 88% and 92%.

As the surge event progresses, energy not shunted to ground by GDT1 and GDT2 (for common mode) and GDT0 (for differential mode) eventually passes through the inductors L1 and L2. This energy may still be of significant voltage and current levels to cause damage to the load 120. Thus, the circuit 300 comprises MOV0, MOV1, and MOV2 in the MOV stage 305B to further limit the voltage and current let through to the load 120. MOV1 and MOV2 offer protection against surge events in the common mode, and MOV0 offers surge protection against surge events in the differential mode.

MOV0, MOV1, and MOV2 act similarly to GDT0, GDT1, and GDT2 in that the MOVs also possess a break down voltage level and are capable of shunting large amounts of surge current to ground but not nearly as much as GDT0, GDT1, and GDT2. The purpose of the MOVs are to bring the current let through the inductors L1 and L2 and the voltage at points 381 and 382 to a level that can be safely handled by the TVS stage 305C. In an exemplary embodiment, the MOV stage 305B shunts about 19% of the overcurrent at LINE IN 311A and RTN IN 312A to ground 390, wherein “about 19%” may mean between 17% and 21%.

Connecting the MOV stage 305B to the TVS stage 305C are the inductors L3 and L4. As with the inductors L1 and L2, the purpose of the inductors L3 and L4 is to limit current to TVS0, TVS1, and TVS2 in the TVS stage 305C by forcing the MOVs in the MOV stage 305B to breakdown before breakdown of the TVS devices 360C, 361C, and 362C in the TVS stage 305C. The current let through the inductors L3 and L4 and the voltage at the outputs 321C and 322C is at a level that can be safely handled by the TVS stage 305C. TVS0, TVS1, and TVS2 break down in the presence of a residual surge voltage at the outputs 321C and 322C, and shunt most of the residual overcurrent to ground 390, wherein “most” may mean between 50% and 100% of the remaining overcurrent passing through the TVS stage 305C. TVS1 and TVS2 are used for common mode protection, and TVS0 is used for differential mode protection. In an exemplary embodiment, the TVS stage 305C shunts about 1% of the overcurrent at LINE IN 311A and RTN IN 312A to ground 390, wherein “about 1%” may mean between 0.5% and 2%. The turn-off times for GDT0, GTD1, and GDT2 and MOV0, MOV1, and MOV2 are generally in the micro-second range, e.g., between 1 μs and 50 μs. TVS0, TVS1, and TVS2 turn off faster. Their turn-off times are generally in the nano-second range, e.g., between 1 ns and 50 ns.

The circuit 300 passes the expected power provided by the source 110 from LINE IN 311A and RTN IN 312A through LINE OUT 321C and RTN OUT 322C while attenuating transient surges present at the inputs 311A and 312A. Any residual surge let present at the outputs 321C and 322C is at a level that can be safely tolerated by the load 120. In an exemplary embodiment, the circuit 100 passes 38A of DC at 48V from inputs 311A and 312A to output 321C and 322C and provides 40KA of surge protection.

The breakdown, clamping, and turn-off voltages of each stage 305A, 305B, and, 305C are application dependent. Generally, the stages 305A, 305B, and, 305C are sized for a coordinated breakdown based on the DC or signal voltage provided at the inputs 311A and 312A. In an exemplary embodiment in which the inputs 311A and 312A are respectively 48V and −48V, if the maximum let-through voltage at the outputs 321N and 322N is 100V, the stage 305A may be selected to have a 600V DC breakdown voltage, a 150V DC clamping voltage, and a <80V DC turn off voltage; the stage 305B may be selected to have a 82V breakdown voltage and a 135V DC clamping voltage; and the stage 305C may be selected to have a 54V breakdown voltage and a 98V clamping voltage. Thus, the clamping voltage of the final stage 305C is desirably between 95% and 98% of the maximum let-through voltage. In such embodiment, When presented with a 40KA surge, the GDT stage 305A breaks down at about 600V, clamping at about 150V; the MOV stage 305B breaks down close to 82V, clamping at about 135V; and the TVS stage 305C breaks down close to 54V, clamping at about 98V, wherein “about” in this context means +/−5% and “close to” means +/−2 V.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

1. A circuit for attenuating a surge comprising:
an input conductor for receiving a signal;
an output conductor for outputting the signal;
a plurality of stages coupled in series in pairs between the input conductor and the output conductor, each of the plurality of stages configured for attenuating a portion of a surge input via the input conductor; and
at least one electrically reactive component, wherein each pair of coupled stages is coupled via at least one of the at least one electrically reactive component.

2. The circuit of claim 1, wherein:
each of the plurality of stages comprises an input conductor, an output conductor, and at least one breakdown device, and
for each of the plurality of stages, the at least one breakdown device of the each stage couples the input conductor of the each stage to ground.

3. The circuit of claim 2, wherein the at least one breakdown device of each of the plurality of stages has a breakdown voltage.

4. The circuit of claim 3, wherein for each coupled pair of the plurality of output stages, the breakdown voltage of the at least one breakdown device of a first stage in the each coupled pair is greater than the breakdown voltage of the at least one breakdown device of a second stage in the each coupled pair.

5. The circuit of claim 1, wherein the input conductor comprises first and second input conductors and the output conductor comprises first and second output conductors.

6. The circuit of claim 5, wherein:
each of the plurality of stages comprises at least first and second input conductors, at least first and second output conductors, and at least first and second breakdown devices, and
for each of the plurality of stages, the first breakdown device of the each stage couples the first input conductor of the each stage to ground, and the second breakdown device of the each stage couples the second input conductor of the each stage to ground.

7. The circuit of claim 6, wherein each of the each of the plurality of stages further comprises at least a third breakdown device coupling the first input conductor of the each stage to the second input conductor of the each stage.

8. The circuit of claim 7, wherein the first, second, and third breakdown devices of each of the plurality of stages has a breakdown voltage.

9. The circuit of claim 8, wherein for each pair of the plurality of output stages, the breakdown voltage of the first, second, and third breakdown devices of a first stage in the each pair is greater than the breakdown voltage of respective ones of the first, second, and third breakdown devices of a second stage in the each pair.

10. A system for providing power, the system comprising:
a source of power;
a load
a circuit for attenuating a surge, the circuit coupled to the source of power and to the load, the circuit comprising:
an input conductor for receiving a signal from the source of power;
an output conductor for outputting the signal to the load;
a plurality of stages coupled in series in pairs between the input conductor and the output conductor, each of the plurality of stages configured for attenuating a portion of a surge input via the input conductor; and
at least one electrically reactive component, wherein each pair of coupled stages is coupled via at least one of the at least one electrically reactive component.

11. The system of claim 10, wherein:
each of the plurality of stages comprises an input conductor, an output conductor, and at least one breakdown device, and
for each of the plurality of stages, the at least one breakdown device of the each stage couples the input conductor of the each stage to ground.

12. The system of claim 11, wherein the at least one breakdown device of each of the plurality of stages has a breakdown voltage.

13. The system of claim 12, wherein for each coupled pair of the plurality of output stages, the breakdown voltage of the at least one breakdown device of a first stage in the each coupled pair is greater than the breakdown voltage of the at least one breakdown device of a second stage in the each coupled pair.

14. The system of claim 10, wherein the input conductor comprises first and second input conductors and the output conductor comprises first and second output conductors.

15. The system of claim 14, wherein:
each of the plurality of stages comprises at least first and second input conductors, at least first and second output conductors, and at least first and second breakdown devices, and
for each of the plurality of stages, the first breakdown device of the each stage couples the first input conductor of the each stage to ground, and the second breakdown device of the each stage couples the second input conductor of the each stage to ground.

16. The system of claim 15, wherein each of the each of the plurality of stages further comprises at least a third breakdown device coupling the first input conductor of the each stage to the second input conductor of the each stage.

17. The system of claim 16, wherein the first, second, and third breakdown devices of each of the plurality of stages has a breakdown voltage.

18. The system of claim 17, wherein for each pair of the plurality of output stages, the breakdown voltage of the first, second, and third breakdown devices of a first stage in the each pair is greater than the breakdown voltage of respective ones of the first, second, and third breakdown devices of a second stage in the each pair.

19. A circuit for attenuating a surge comprising:
a first input conductor for receiving a first signal;
a first output conductor for outputting the first signal;
at least a first, second, and third stage coupled in series between the first input conductor and the first output conductor, each stage comprising a first input to which a first voltage is applied, a first output coupled to the first input of the each stage, and a first breakdown device coupled between the first input of the each stage and ground, the first breakdown device of the each stage configured to turn on when the first voltage at the first input of the each stage exceeds a first threshold value and to turn off when the first voltage at the first input of the each stage decreases to less than a second threshold value;
at least two electrically reactive components, a first of the at least two electrically reactive components coupling the first output of the first stage to the first input of the second stage, a second of the at least two electrically reactive components coupling the first output of the second stage to the first input of the third stage.

20. The circuit of claim 19, further comprising:
a second input conductor for receiving a second signal; and
a second output conductor for outputting the second signal,
wherein each stage further comprises a second input to which a second voltage is applied a second output coupled to the second input of the each stage, and a second breakdown device coupled between the second input of the each stage and ground, the second breakdown device of the each stage configured to turn on when the second voltage at the second input of the each stage exceeds a first threshold value and to turn off when the second voltage at the second input of the each stage decreases to less than a second threshold value;

21. The circuit of 20, further comprising at least two further electrically reactive components, a first of the at least two further electrically reactive components coupling the second output of the first stage to the second input of the second stage, a second of the at least two electrically reactive components coupling the second output of the second stage to the second input of the third stage.

22. The circuit of claim 20, wherein:
the first and second breakdown devices of the first stage are gas discharge tubes,
the first and second breakdown devices of the second and third stages are solid state breakdown devices, and
each of the at least two electrically reactive components and the at least two further electrically reactive components is an inductor.
